(19) United States
(12) Patent Application Publication
(10) Pub. No.: US 2004/0001313 A1
(43) Pub. Date: Jan. 1, 2004

(54) Electrode apparatus having a front door covering a front surface of a housing

(75) Inventor: Hitoshi Yoshikara, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/421,807

(22) Filed: Apr. 24, 2003

(30) Foreign Application Priority Data
Jun. 28, 2002 (JP) 2002-190898

(51) Int. Cl. G06F 1/20; F28F 7/00

(52) U.S. Cl. 361/687; 361/695; 361/683; 165/80.3

(57) ABSTRACT

An electronic apparatus includes a housing and a front door movable between a closed position and an open position. The housing houses a heat generating component, a peripheral equipment and a fan device. The peripheral equipment has an insertion port through which a storage medium is inserted. The insertion port is opened in the front surface of the housing. The fan device draws air through air intake holes formed in the front door and discharges the drawn air through the housing. The front door has a cover portion. The cover portion covers the insertion port of the peripheral equipment, so long as the front door is at the closed position.

### CROSS-REFERENCE TO RELATED APPLICATIONS

This application is based upon and claims the benefit of priority from the prior Japanese Patent Application No. 2002-190898, filed Jun. 28, 2002, the entire contents of which are incorporated herein by reference.

### BACKGROUND OF THE INVENTION

1. Field of the Invention

The present invention relates to an electronic apparatus incorporating peripheral equipments such as a digital audio tape apparatus and a magneto-optical disk apparatus, and more particularly to a structure to improve anti-dust properties of the peripheral equipments.

2. Description of the Related Art

A PC server as an electronic apparatus has a box-shaped housing having air holes in the front surface thereof, and a front door supported by the housing. The housing houses principal structural elements, for example, a micro processor, a power source unit, a plurality of hard disk drives, a CD-ROM drive, a digital audio tape apparatus and a magneto-optical disk apparatus. Of these structural elements, the CD-ROM drive, the digital audio tape apparatus and the magneto-optical disk apparatus each have an insertion port, through which a recording medium, such as an optical disk or a tape cassette, is removably inserted. The insertion ports are opened in the front surface of the housing.

The front door has a plurality of air intake holes. The front door is rotatable between a closed position covering the front surface of the housing and an open position exposing the front surface of the housing. When the front door is rotated to the open position, the insertion ports are exposed to the front surface of the housing, so that, for example, an optical disk can be inserted in or removed from the magneto-optical disk apparatus.

In the PC server, which handles a large volume of data, the heat generated by the microprocessor and the hard disk drives generate is increased, as the processing speed and the number of functions is increased. Therefore, the conventional PC server has a fan device to cool the microprocessor and the hard disk drives. When the fan device is driven, the air outside the housing is drawn to the inside of the housing from the air intake holes in the front door through the air holes of the housing. The drawn air cools the microprocessor, the hard disk drives and the power source unit while flowing through the inside of the housing. The air heated through this process is discharged through the back surface of the housing.

The peripheral equipments, such as the magneto-optical disk apparatus and the digital audio tape apparatus, generate less heat as compared to the microprocessor and the hard disk drives. Therefore, less air than that to cool the microprocessor and the like the air may suffice to cool the peripheral equipments.

The fan device takes in, through the air intake holes of the front door, the air of an amount enough to fully cool the structural elements that generate a large amount of heat, e.g., the microprocessor. Part of the air taken in through the air intake holes also flows around the peripheral equipments. For this reason, the peripheral equipments are exposed to excessive airflow. In particular, since the insertion ports of the peripheral equipments are open in the front surface of the housing, the excessive air inevitably flows into the peripheral equipments through the insertion ports. The air taken in the housing contains dusts in the atmosphere. Therefore, the dust is drawn into the peripheral equipments together with the air, and adheres to the recording media inserted in the peripheral equipments or the reading mechanisms inside the peripheral equipments.

Consequently, the dust stains the recording media and the reading mechanisms, resulting in difficulties in reading information from the recording medium or reading error.

### BRIEF SUMMARY OF THE INVENTION

According to an embodiment of the present invention, there is provided an electronic apparatus comprising: a housing having a front surface; a heat generating component housed in the housing; a peripheral equipment housed in the housing, the peripheral equipment having an insertion port through which a storage medium is removably inserted, the insertion port being opened in the front surface of the housing; a front door supported by the housing, the front door having a plurality of air intake holes and being movable between a closed position at which the front door covers the front surface of the housing and an open position at which the front surface of the housing is exposed; and a fan device which is housed in the housing, and which draws air through the air intake holes in the front door and discharges the drawn air through the housing. The front door has a cover portion which covers the insertion port of the peripheral equipment when the front door is at the closed position.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a PC server according to a first embodiment of the present invention.

FIG. 2 is a perspective view of the PC server according to the first embodiment of the present invention, showing a state in which a front door is at an open position and the front surface of the housing is exposed.

FIG. 3 is a front view of the PC server according to the first embodiment of the present invention, showing the front surface of the housing.

FIG. 4 is a perspective view showing the positional relationship between the front door and an inner lid in the first embodiment of the present invention.

FIG. 5 is a cross-sectional view of the PC server according to the first embodiment, schematically showing the positional relationship between the front surface of the housing and the inner lid, when the front door is at a closed position.

FIG. 6 is a perspective view showing the positional relationship between the front door and the inner lid in a second embodiment of the present invention.

FIG. 7 is a cross-sectional view of the PC server according to the second embodiment, schematically showing a state in which the front door is at the closed position and all through holes of the inner lid are closed by a closing plate.

FIG. 8A is a cross-sectional view of the PC server according to the second embodiment, schematically showing the state in which the closing plate is removed from the main body of the inner lid, so that all through holes of the main body are opened.

FIG. 8B is a cross-sectional view of the PC server according to the second embodiment, schematically showing the state in which an air quantity adjusting plate is attached to the main body of the inner lid, so that a part of through holes are opened.

FIG. 9 is a perspective view of a PC server according to a third embodiment of the present invention.

FIG. 10 is a perspective view of the PC server according to the third embodiment, showing a state in which first and second front doors are at the open position, so that the front surface of the housing is exposed.

FIG. 11 is a cross-sectional view of the PC server according to the third embodiment, schematically showing the state in which the first and second front doors are at the closed position.

### DETAILED DESCRIPTION OF THE INVENTION

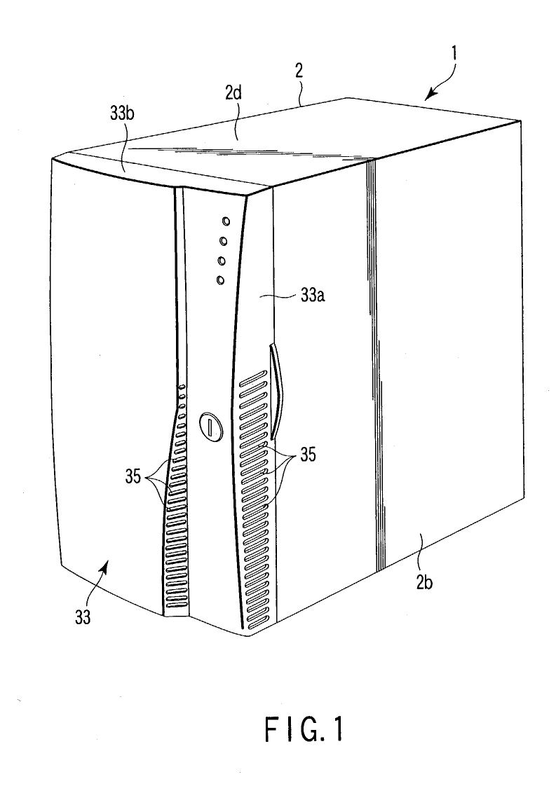

A first embodiment of the present invention will be described with reference to FIGS. 1 to 5.

FIG. 1 shows a PC server 1 as an electronic apparatus. The PC server 1 has a box-shaped housing 2. The housing 2 has a bottom wall 2a, left and side walls 2b, a front wall 2c, a top wall 2d and a rear wall 2e. The front wall 2c constitutes a front surface 11 of the housing 2.

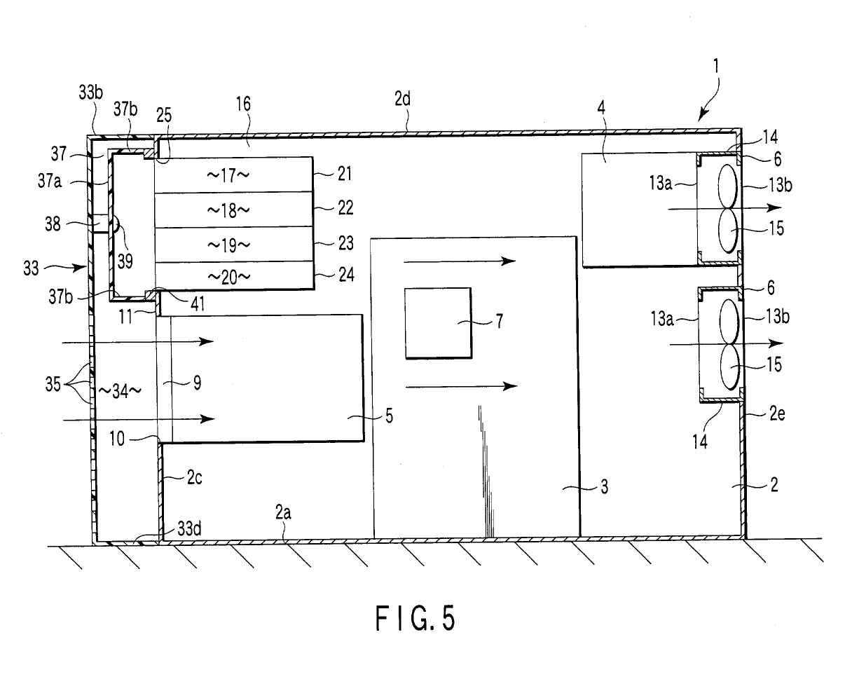

As shown in FIG. 5, the housing 2 contains a printed wiring board 3, a power source unit 4, a plurality of hard disk drives 5, and a pair of fan devices 6. The printed wiring board 3 stands up along the side walls 2b of the housing 2. A microprocessor 7 as a heat generating component is mounted on the printed wiring board 3. The power source unit 4 is located behind the printed wiring board 3.

The hard disk drives 5 are located in front of the printed wiring board 3 and in a middle portion of the housing 2 along the height direction of the housing 2. The hard disk drives 5 are arranged in a line along the width direction of the housing 2. The microprocessor 7 and the hard disk drives 5 generate a large amount of heat, since they process a great deal of data at high speed. Therefore, it is necessary to cool them to maintain stable operations.

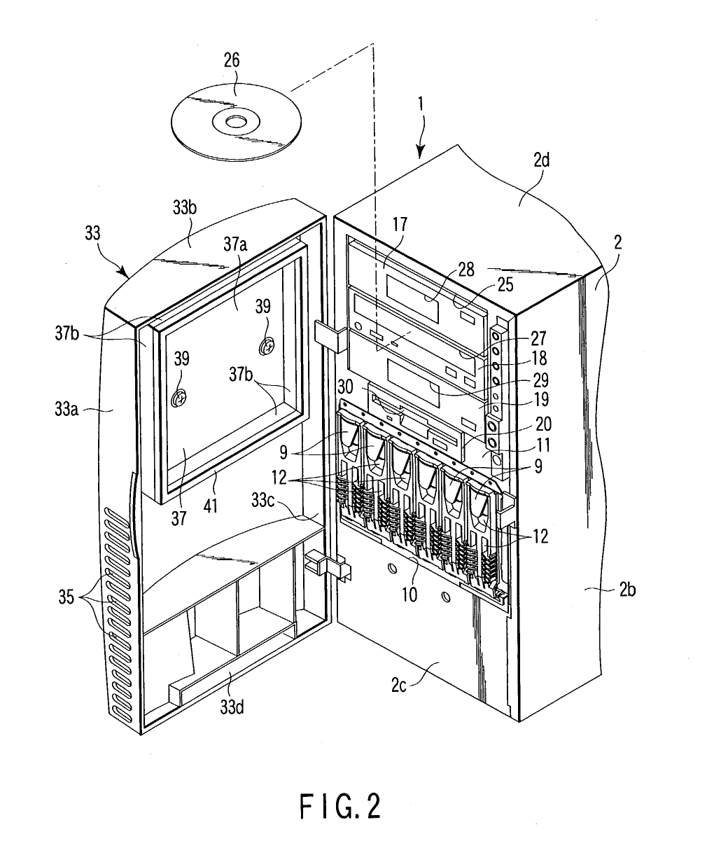

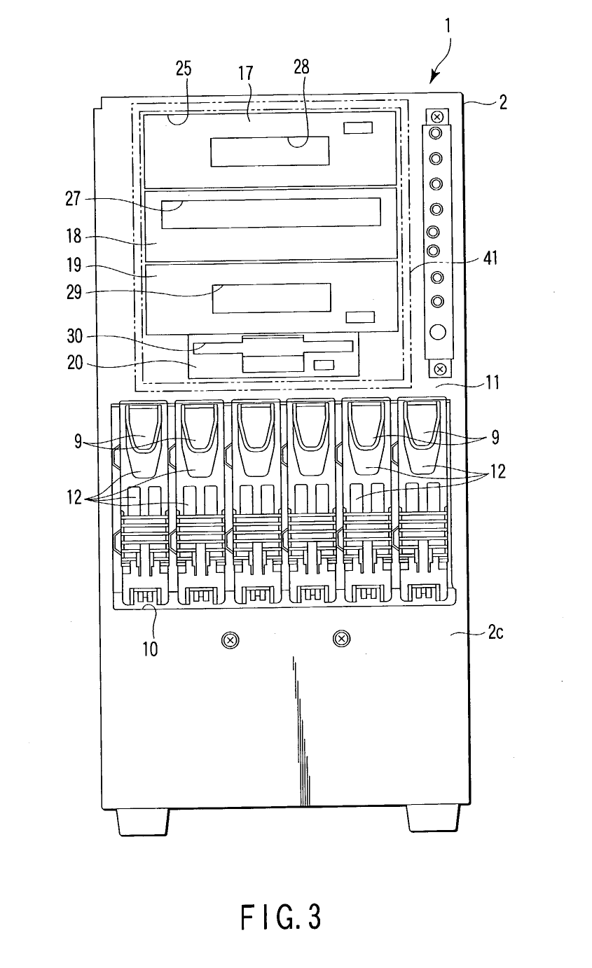

Each of the hard disk drives 5 has an operation lever 9 in its front end portion. The operation lever 9 is used to take the hard disk drive 5 in and out of the housing 2. As shown in FIGS. 2 and 3, the operation levers 9 of the hard disk drives 5 are arranged in a line along the width direction of the housing 2, and located within an opening 10 formed in the front wall 2c. Each operation lever 9 has a plurality of air holes 12 communicating with the inside of the housing 2. The air holes 12 are exposed to the front surface 11 of the front wall 2c through the opening 10.

The fan devices 6 are supported by the rear wall 2e of the housing 2. Each fan device 6 includes a fan casing 14 having an air intake port 13a and an air discharge port 13b. The fan device 6 also includes an impeller 15 contained in the fan casing 14. The air discharge port 13b of the fan casing 14 opens through the rear wall 2e of the housing 2.

The housing 2 further includes a packaging region 16. The packaging region 16 is located above the hard disk drives 5, and has a packaging port 25 opening through the front wall 2c of the housing 2. The packaging port 25 is positioned just above the opening 10. The packaging region 16 stores a plurality of peripheral equipments. The peripheral equipments used in this embodiment are a digital audio tape apparatus 17, a CD-ROM drive 18, a magneto-optical disk apparatus 19 and a floppy disk drive 20. These apparatuses 17 to are stacked in a line along the height direction of the housing 2.

The apparatuses 17 to 20 respectively have flat box-shaped chassis 21 to 24. The front surfaces of the chassis 21 to 24 are exposed through the packaging port of the housing 2 to the front surface 11 of the housing 2. The chassis 21 of the CD-ROM drive 18 has an insertion port 27. The insertion port 27 opens in the front surface of the chassis 21, and allows an optical disk 26 (shown in FIG. 2) as a recording medium to be removably inserted therethrough. The chassis 22 of the digital audio tape apparatus 17 has an insertion port 28. The insertion port 28 opens in the front surface of the chassis 22, and allows a tape cassette (not shown) as a recording medium to be removably inserted therethrough. The chassis 23 of the magneto-optical disk apparatus 19 has an insertion port 29. The insertion port 29 opens in the front surface of the chassis 23, and allows an optical disk (not shown) as a recording medium to be removably inserted therethrough. The chassis 24 of the floppy disk drive 20 has an insertion port 30. The insertion port 30 opens in the front surface of the chassis 24, and allows a floppy disk (not shown) as a recording medium to be removably inserted therethrough.

As shown in FIGS. 1 and 2, the PC server 1 has a front door 33 made of synthetic resin. The front door 33 has dimensions corresponding to the front wall 2c of the housing 2. Four flange portions 33a to 33d are formed on the peripheral edges of the front door 33. The flange portions 33a to 33d protrude from the peripheral edges of the front door 33 toward the front wall 2c, and the distal end edges of the four flange portions are located on one plane.

The front door 33 is supported at a front end of the housing 2, and rotatable between a closed position and an open position. In the state where the front door 33 is at the closed position, the front surface 11 of the housing 2 is covered with the front door 33, and the distal end edges of the flange portions 33a to 33d of the front door 33 face the peripheral portion of the front surface 11. In the state where the front door 33 is at the open position, the front door 33 is retreated at a side portion of the housing 2, and the front surface 11 of the housing 2, the air holes 12 of the operation levers 9 and the insertion ports 27 to 30 of the peripheral equipments 17 to 20 are exposed to the outside of the housing 2.

As shown in FIG. 5, when the front door 33 is at the closed position, an air intake chamber 34 is formed between the front door 33 and the front surface 11 of the housing 2. The air holes 12 of the operation levers 9 positioned in the front surface 11 of the housing 2 are opened to the air intake chamber 34. A plurality of air intake holes 35 are formed in a central portion of the front door 33 and the flange portion 33a located at one side of the front door 33. The air intake holes 35 are arranged in a line along the height direction of the front door 33 at intervals and opened to the air intake chamber 34.

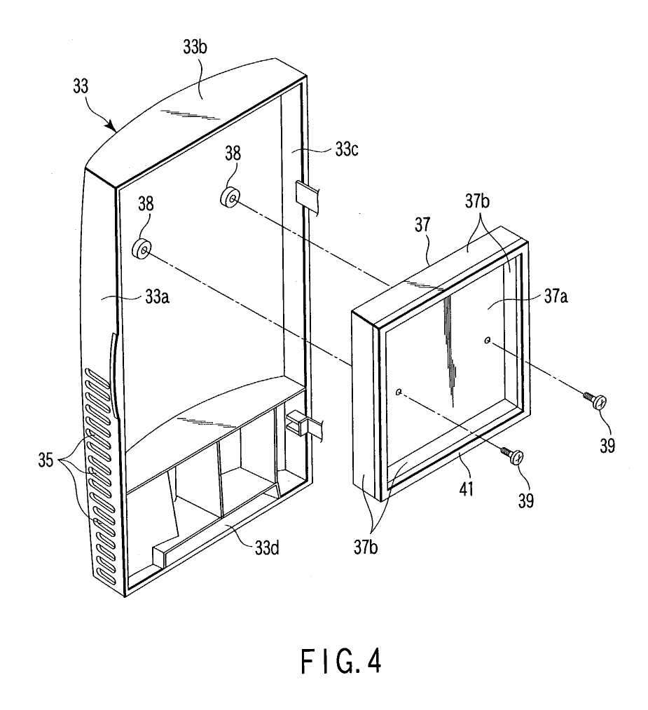

As shown in FIGS. 4 and 5, an inner lid 37 as a cover portion is attached to the inner surface of the front door 33. The inner lid 37 is made of synthetic resin. The inner lid 37 has a rectangular end plate 37a and four side plates 37b rising from the peripheral edge of the end plate 37a.

The end plate 37a is one size larger than the packaging port 25 formed in the front surface 11 of the housing 2. The end plate 37a is detachably supported to a pair of boss portions 38 projected from the inner surface of the front door 33 by screws 39. The side plates 37b have distal end edges. The distal end edges face the front surface 11 of the housing 2 and surround the packaging port 25, when the front door 33 is at the closed position.

A seal member 41 is attached to the distal end edges of the side plates 37b. The seal member 41 is formed of an elastically deformable material, such as sponge or a rubber-like elastic body. When the front door 33 is at the closed position, the seal member 41 is in close contact with the front surface 11 of the housing 2 so as to surround the packaging port 25 (see FIG. 3). In other words, the seal member 41 is sandwiched between the front surface 11 of the housing 2 and the distal end edges of the side plates 37b.

Therefore, as long as the front door 33 is at the closed position, the inner lid 37 closes the insertion ports 27 to 30 of the peripheral equipments 17 to 20 inside the air intake chamber 34. As a result, the insertion ports 27 to 30 are kept shielded from the air intake chamber 34.

In the PC server 1 having the structure described above, when the impellers 15 of the fan devices 6 rotate, the air inside the housing 2 is drawn in the air intake ports 13a of the fan casings 14. As a result, the static pressure in the housing 2 is lowered, and the air outside the housing 2 is drawn into the air intake chamber 34 through the air intake holes 35 of the front door 33, as indicated by arrows in FIG. 5. The air taken in the air intake chamber 34 is drawn into the inside of the housing 2 through the air holes 12. The air cools the hard disk drives 5, the microprocessor 7 and the power source unit 4, while it is flowing in the housing 2. The air is heated by the heat exchange in this process, and discharged out of the housing 2 through the air discharge ports 13b of the fan casings 14.

In the above structure, when the front door 33 is at the closed position, the inner lid 37 faces the insertion ports 27 to 30 of the peripheral equipments 17 to 20. In addition, the seal member 41 of the inner lid 41 is in close contact with the front surface 11 of the housing 2 so as to surround the insertion ports 27 to 30. For this reason, as long as the front door 33 is closed, the insertion ports 27 to 30 are kept hermetically sealed. Therefore, most part of the air taken in through the air intake holes 35 of the front door 33 is drawn into the housing 2 through the air holes 12 formed in that region of the front surface 11 of the housing 2 which excludes the inner lid 37.

Accordingly, since the amount of air flowing into the insides of the peripheral equipments 17 to 20 through the insertion ports 27 to 30 can be small, the dust contained in the air cannot be easily enter the insides of the peripheral equipments 17 to 20. As a result, the optical disk 26 and the reading mechanism are prevented from staining due to dust. Hence, malfunctions of the peripheral equipments, such as a reading error, can be prevented.

The inner lid 37 can be removed from the front door 33 by loosening the screws 39. Therefore, for example, when a hard disk drive that generates a large amount of heat is to be incorporated into the packaging region 16, cooling air can be introduced to the hard disk drive by removing the inner lid 37.

In the first embodiment described above, the front door 33 and the inner lid 37 are separate components. However, the present invention is not limited to this structure. For example, the inner lid 37 is formed integral with the inner surface of the front door 33.

Further, in the above embodiment, the single inner lid covers the insertion ports of all of the peripheral equipments. However, the present invention is not limited to this structure. For example, the inner lid may cover the insertion port of one of the peripheral equipments: a specific peripheral equipment that should most be kept away from dust.

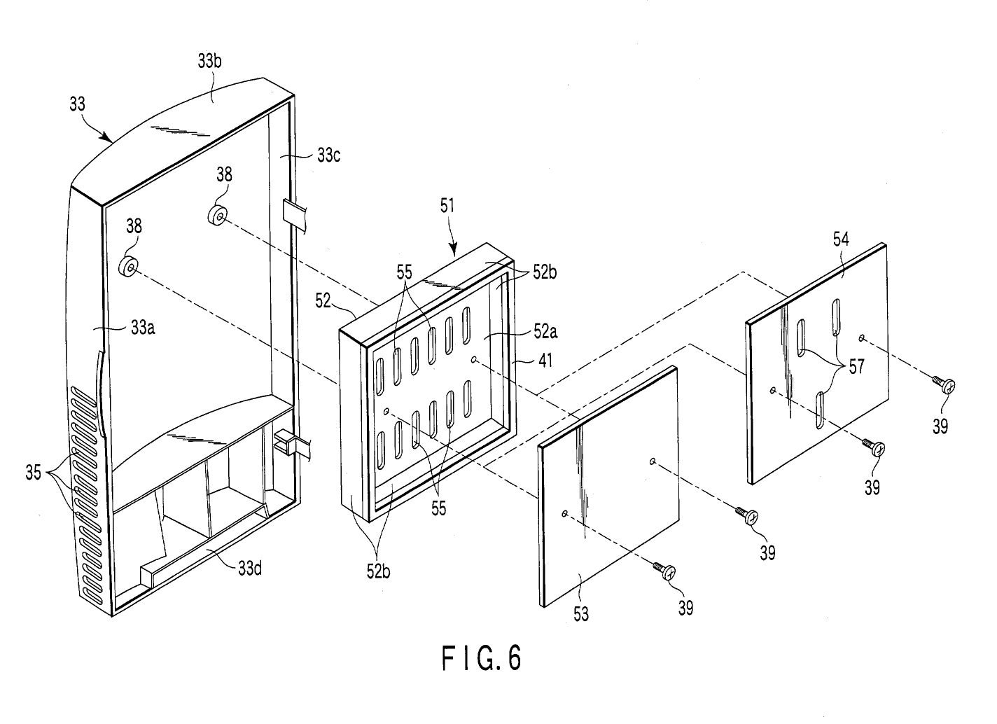

FIGS. 6 to 8 show a second embodiment of the present invention.

The second embodiment is different from the first embodiment in structure of an inner lid 51. The other basic structure of the PC server 1 is the same as that of the first embodiment. Therefore, the components of the second embodiment that are the same as those of the first embodiment are identified by the same reference numerals as those used for the first embodiment, and the descriptions thereof will be omitted.

As shown in FIG. 6, the inner lid 51 has a main body 52, a blocking plate 53 and an air quantity adjusting plate 54. The main body 52 has a rectangular end plate 52a and four side plates 52b rising from the peripheral edge of the end plate 52a. The end plate 52a is one size larger than the packaging port 25 formed in the front surface 11 of the housing 2, and detachably supported to the boss portions 38 of the front door 33 by the screws 39. The end plate 52a has a plurality of through holes 55. The through holes 55 are opened to a gap 56 between the end plate 52a and the inner surface of the front door 33. Further, the through holes 55 face the packaging port 25 of the front surface 11 of the housing 2.

The side plates 52b have distal end edges. The distal end edges face the front surface 11 of the housing 2 and surround the packaging port 25, when the front door 33 is at the closed position. A seal member 41 as used in the first embodiment is attached to the distal end edges of the side plates 52b.

The blocking plate 53 is overlaid on the end plate 52a of the main body 52. The blocking plate 53 is removably fixed to the end plate 52a by means of the screws 39. As a result, the blocking plate 53 blocks all of the through holes 55 from the side of the front surface 11 of the housing 2.

The air quantity adjusting plate 54 is used in exchange for the blocking plate 53, and overlaid on the end plate 52a of the main body 52. The air quantity adjusting plate 54 has a plurality of communication holes 57. The communication holes 57 are less than the through holes 55 of the end plate 52a. The air quantity adjusting plate 54 is removably fixed to the end plate 52a by means of the screws 39 from the side of the front surface 11 of the housing 2. In the state where the air quantity adjusting plate 54 is fixed to the end plate 52a, the communication holes 57 coincide with some of the through holes 55. The other through holes 55 are blocked with the air quantity adjusting plate 54.

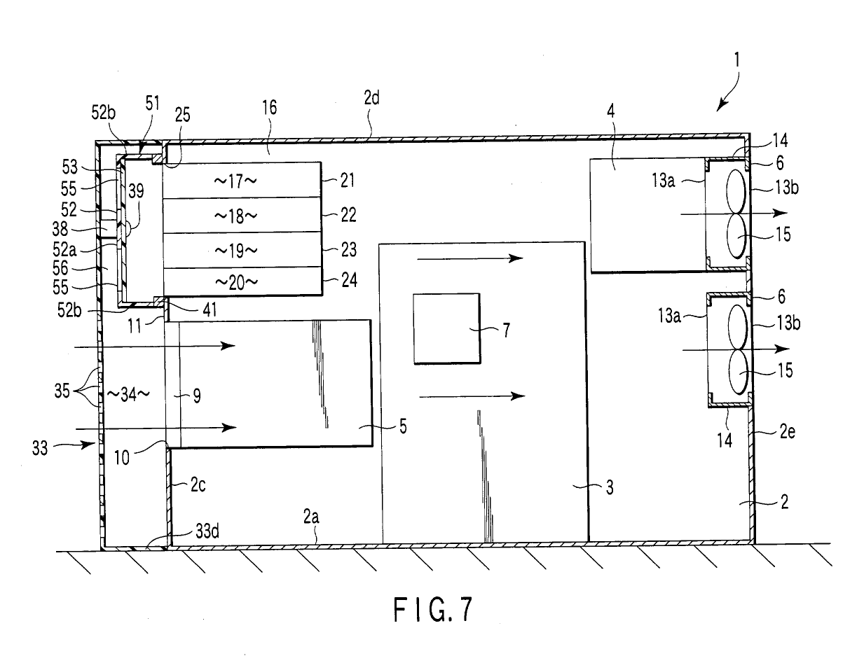

With this structure, in the state where the blocking plate 53 is fixed to the end plate 52a of the inner lid 51 as shown in FIG. 7, the blocking plate 53 blocks all of the through holes 55 of the end plate 52a. For this reason, as long as the front door 33 is closed, the insertion ports 27 to 30 of the peripheral equipments 17 to 20 are kept hermetically sealed. Therefore, most of the air taken in through the air intake holes 35 of the front door 33 is drawn into the housing 2 through the air holes 12.

Accordingly, the amount of air flowing into the insides of the peripheral equipments 17 to 20 through the insertion ports 27 to 30 can be small. Therefore, malfunctions of the peripheral equipments 17 to 20 due to dust contained in the air can be prevented.

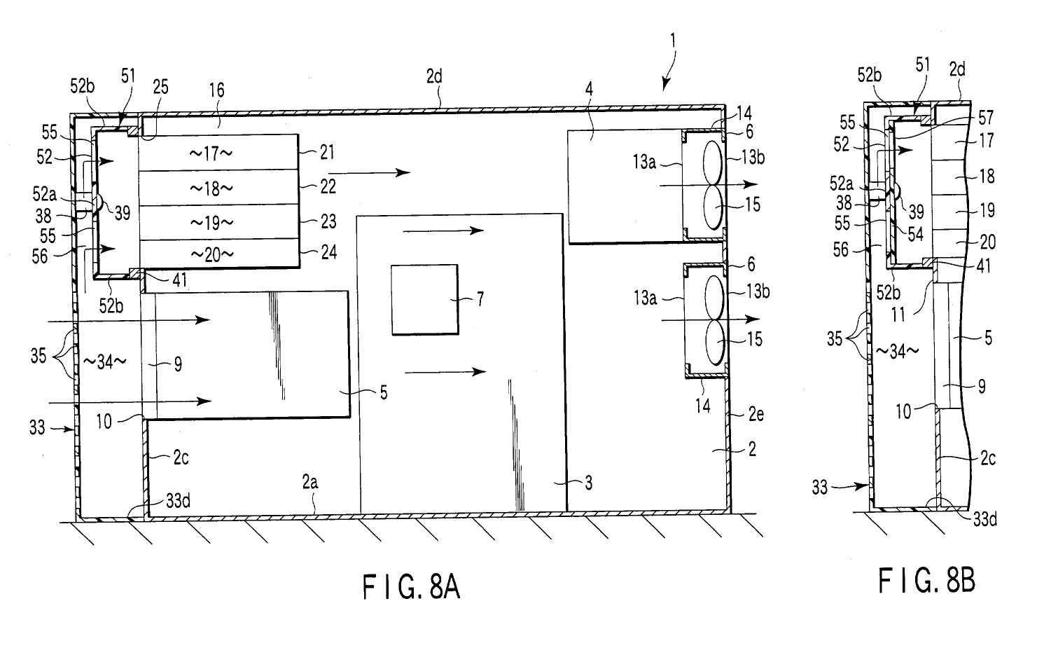

When the blocking plate 53 is removed from the end plate 52a of the inner lid 51 as shown in FIG. 8A, all of the through holes 55 of the end plate 52a are opened. Therefore, part of the air, drawn through the air intake holes 35 into the air intake chamber 34 when the fan devices 6 are driven, flows from the gap 56 between the front door 33 and the end plate 52a through the through holes 55 into the inside from the inner lid 51.

Consequently, for example, when a hard disk drive which requires cooling is to be loaded into the packaging region 16 of the housing 2, cooling air can be introduced to the hard disk drive through the through holes 55 of the end plate 52a.

When the air quantity adjusting plate 54, in exchange for the blocking plate 53, is attached to the end plate 52a of the inner lid 51 as shown in FIG. 8B, only some of the through holes 55 of the end plate 52a are kept open. Therefore, the amount of the air introduced into the inside from the inner lid 51 is less as compared to the case where all of the through holes 55 are open.

As a result, by attaching either the blocking plate 53 or the air quantity adjusting plate 54 to the end plate 52a of the main body 52 or removing both, one of the following three states can be easily obtained: all of the through holes 55 of the end plate 52a are open; some of the through holes 55 are open; and all of the through holes 55 are closed. Thus, the open area of the through holes 55 can be adjusted in accordance with the amount of heat generated by the apparatuses loaded in the packaging region 16 of the housing 2, thereby optimizing the amount of cooling air introduced to the apparatus.

In the second embodiment described above, the front door 33 and the inner lid 51 are separate components. However, the present invention is not limited to this structure. For example, the main body 52 of the inner lid 51 may be formed integral with the inner surface of the front door 33.

Further, a plurality of air quantity adjusting plates 54 having communication holes 57, which are different in number or size, may be prepared, so that one of the air quantity adjusting plates 54 can be selectively attached to the end plate 52a of the main body 52. With this modification, the amount of cooling air guided to the packaging region 16 of the housing 2 can be changed stepwise.

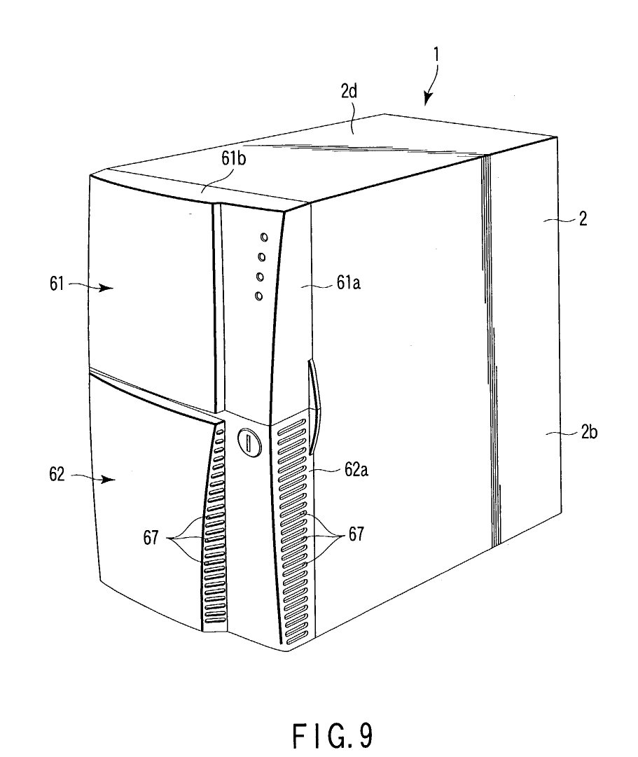

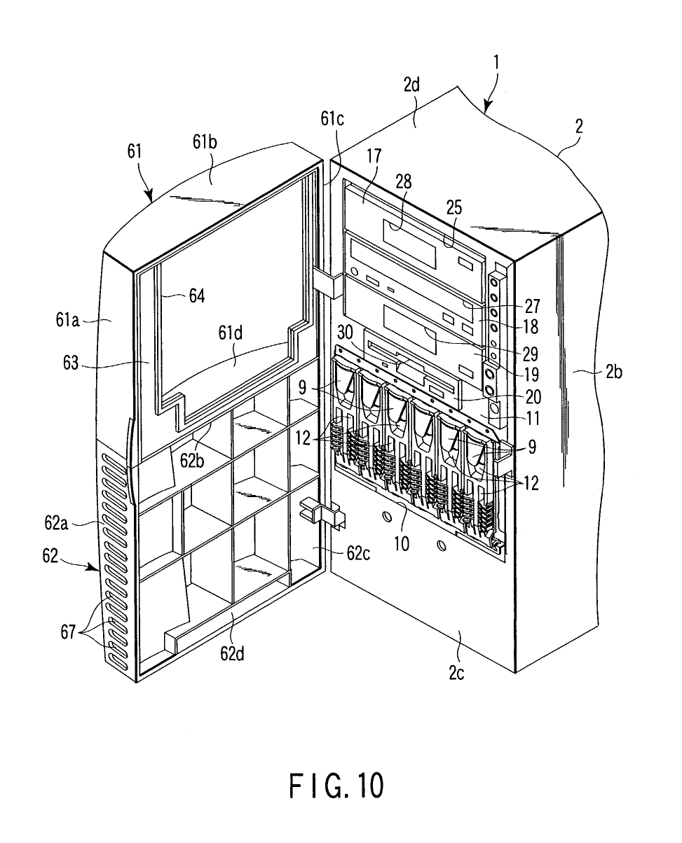

FIGS. 9 to 11 show a third embodiment of the present invention.

The PC server 1 of the third embodiment has a first front door 61 and a second front door 62. The other structure of the PC server 1 is the same as that of the first embodiment.

The first front door 61 is supported to an upper portion of the front end of the housing 2, and rotatable between the open position and the closed position. The first front door 61 has a size corresponding to the upper half area of the front surface 11 of the housing 2. The packaging port 25 is located in the upper half of the front surface 11. Four flange portions 61a to 61d protruded toward the front surface 11 of the housing 2 are formed on the peripheral edges of the first front door 61. The distal end edges of the four flange portions 61a to 61d are located on one plane. Further, an extended portion 63 protruded inward is formed at the distal end edges of the flange portions 61a to 61d.

In the state where the first front door 61 is at the closed position, it covers the upper half area of the front surface 11 of the front wall 2c. In addition, the extended portion 63 of the first front door 61 faces the front surface 11 of the housing 2. A seal member 64 is attached to the extended portion 63. The seal member 64 is formed of an elastically deformable material, such as sponge or a rubber-like elastic body. When the first front door 61 is at the closed position, the seal member 64 is in close contact with the front surface 11 of the housing 2 so as to surround the packaging port 25. In other words, the seal member 64 is sandwiched between the front surface 11 of the housing 2 and the extended portion 63 of the first front door 61. Therefore, as long as the first front door 61 is closed, the insertion ports 27 to 30 of the peripheral equipments 17 to 20 are kept closed.

In the state where the first front door 61 is at the open position, it is retreated at a side portion of the housing 2. Therefore, the upper half area of the front surface 11 of the housing 2 and the insertion ports 27 to 30 of the peripheral equipments 17 to 20 are exposed to the outside of the housing 2.

The second front door 62 is supported to a lower portion of the front end of the housing 2, and rotatable between the open position and the closed position. The second front door 62 has a size corresponding to the lower half area of the front surface 11 of the housing 2. The air holes 12 of the operation levers 9 are located in the lower half of the front surface 11. Four flange portions 62a to 62d protruded toward the front surface 11 of the housing 2 are formed on the peripheral edges of the second front door 62. The distal end edges of the four flange portions 62a to 62d are located on one plane.

In the state where the second front door 62 is at the closed position, it covers the lower half area of the front surface 11 of the housing 2. In addition, the distal end edges of the flange portions 62a to 62d of the second front door 62 abut to the peripheral portion of the front surface 11. Further, when the second front door 62 is at the closed position, an air intake chamber 66 is formed between the second front door 62 and the front surface 11 of the housing 2. The air holes 12 of the operation levers 9 are opened to the air intake chamber 66. A plurality of air intake holes 67 are formed in a central portion of the second front door 72 and the flange portion 62a located at one side of the front door 62. The air intake holes 67 are arranged in a line along the height direction of the second front door 62 at intervals and opened to the air intake chamber 66.

In the state where the second front door 62 is at the open position, it is retreated at a side portion of the housing 2. As a result, the operation levers 9 are exposed to the outside of the housing 2.

In the above structure, when the first front door 61 is at the closed position, it faces the insertion ports 27 to 30 of the peripheral equipments 17 to 20. Further, the seal member 64 is in close contact with the upper half of the front surface 11 of the housing 2 so as to surround the insertion ports 27 to 30. Therefore, as long as the first front door 61 is closed, the insertion ports 27 to 30 are kept hermetically sealed.

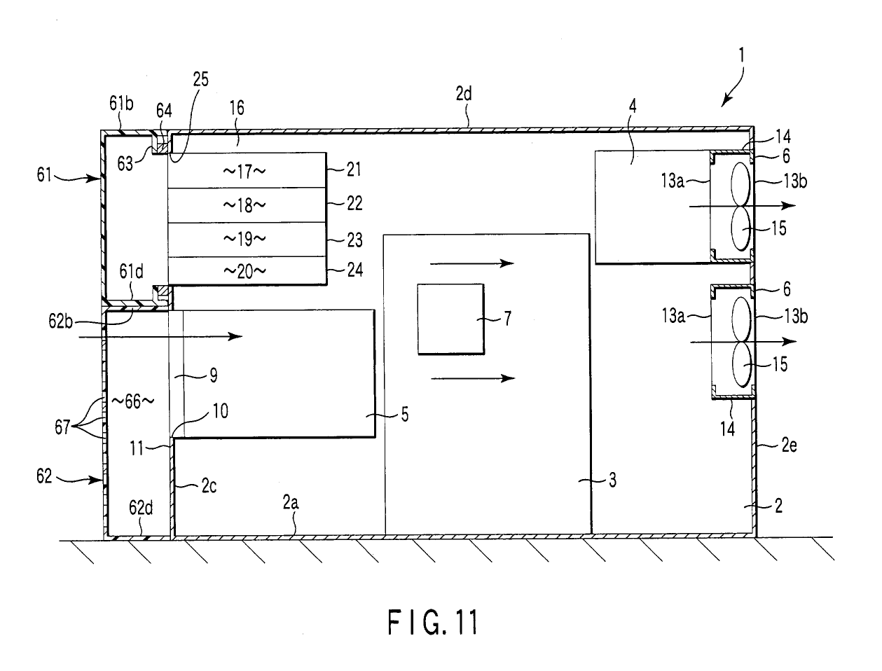

When the fan devices 6 are driven, the air outside the housing 2 is mostly drawn into the air intake chamber 66 through the air intake holes 67, as indicated by an arrow in FIG. 11. The air taken in the air intake chamber 66 is drawn into the inside of the housing 2 through the air holes 12, and cools the hard disk drives 5, the microprocessor 7 and the power source unit 4, while it is flowing in the housing 2.

Thus, as in the first embodiment, the amount of air flowing into the insides of the peripheral equipments 17 to 20 through the insertion ports 27 to 30 can be small. Therefore, malfunctions of the peripheral equipments 17 to 20 due to dust contained in the air can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a housing having a front surface;
a heat generating component housed in the housing;
a peripheral equipment housed in the housing, the peripheral equipment having an insertion port through which a storage medium is removably inserted, the insertion port being opened in the front surface of the housing;
a front door supported by the housing, the front door having a plurality of air intake holes and being movable between a closed position at which the front door covers the front surface of the housing and an open position at which the front surface of the housing is exposed, the front door having a cover portion which closes the insertion port of the peripheral equipment when the front door is at the closed position; and
a fan device which is housed in the housing, and which draws air through the air intake holes in the front door and discharges the drawn air through the housing.

2. The electronic apparatus according to claim 1, wherein the front door constitutes an air intake chamber between itself and the front surface of the housing when the front door is at the closed position, and the front surface of the housing has a plurality of air holes opened to the air intake chamber.

3. The electronic apparatus according to claim 2, wherein the cover portion is located within the air intake chamber and faces the insertion port of the peripheral equipment when the front door is at the closed position.

4. The electronic apparatus according to claim 1, wherein the cover portion is removably supported by the front door.

5. The electronic apparatus according to claim 1, wherein the cover portion has a seal member which is elastically deformable, and the seal member surrounds the insertion port and is in close contact with the front surface of the housing when the front door is at the closed position.

6. The electronic apparatus according to claim 2, wherein the cover portion has a main body supported by the front door and having a plurality of through holes opened to the air intake chamber, and a blocking plate which is selectively removably supported by the main body and closes the through holes.

7. The electronic apparatus according to claim 6, wherein the housing has a packaging region in which the peripheral equipment is removably stored, and the through holes of the main body face the packaging region.

8. The electronic apparatus according to claim 7, wherein the blocking plate is removed from the main body, when the packaging region of the housing stores an apparatus which generates heat during operation.

9. The electronic apparatus according to claim 5, wherein the cover portion has an edge portion which faces the front surface of the housing when the front door is at the closed position, and the seal member is attached to the edge portion.

10. The electronic apparatus according to claim 9, wherein the seal member is sandwiched between the edge portion of the cover portion and the front surface of the housing, when the front door is at the closed position.

11. An electronic apparatus comprising:
a housing having a front surface;
a heat generating component housed in the housing;
a peripheral equipment housed in the housing, the peripheral equipment having an insertion port through which a storage medium is removably inserted, the insertion port being opened in the front surface of the housing;
a front door supported by the housing, the front door having a plurality of air intake holes and being movable between a closed position at which the front door covers the front surface of the housing and an open position at which the front surface of the housing is exposed;
a cover portion which covers the insertion port of the peripheral equipment when the front door is at the closed position, the cover portion including a main body supported by the front door and having a plurality of through holes communicated with the air intake holes, a blocking plate which is selectively removably supported by the main body and closes the through holes, and at least one air quantity adjusting plate which is removably supported by the main body in exchange for the blocking plate and closes a part of the through holes; and
a fan device which is housed in the housing, and which draws air through the air intake holes in the front door and discharges the drawn air through the housing.

12. The electronic apparatus according to claim 11, wherein the front door constitutes an air intake chamber between itself and the front surface of the housing when the front door is at the closed position, the through holes of the main body are opened to the air intake chamber, and the front surface of the housing has a plurality of air holes opened to the air intake chamber.

13. The electronic apparatus according to claim 11, wherein the cover portion has a seal member which is elastically deformable, and the seal member surrounds the insertion port and is in close contact with the front surface of the housing when the front door is at the closed position.

14. The electronic apparatus according to claim 11, wherein the housing has a packaging region in which the peripheral equipment is removably stored, and the blocking plate is removed from the main body, when the packaging region of the housing stores an apparatus which generates heat during operation.

15. The electronic apparatus according to claim 14, wherein the air quantity adjusting plate is supported by the main body when the blocking plate is removed from the main body.

16. An electronic apparatus comprising:
a housing having a front surface;
a heat generating component housed in the housing;
a peripheral equipment housed in the housing, the peripheral equipment having an insertion port through which a storage medium is removably inserted, the insertion port being opened in the front surface of the housing;
a fan device which is housed in the housing, and which draws air through the air intake holes in the front door and discharges the drawn air through the housing;
a first front door supported by the housing, the first front door being movable between a closed position at which the first front door covers a first region of the front surface of the housing where the insertion port is opened and an open position at which the first region is exposed; and
a second front door supported by the housing, the second front door having a plurality of air intake holes and being movable between a closed position at which the second front door covers a second region excluding the first region of the front surface of the housing and an open position at which the second region is exposed.

17. The electronic apparatus according to claim 16, wherein the second front door constitutes an air intake chamber between itself and the front surface of the housing when the second front door is at the closed position, and the front surface of the housing has a plurality of air holes opened to the air intake chamber.

18. The electronic apparatus according to claim 16, wherein the first front door has a seal member which is elastically deformable, and the seal member surrounds the insertion port and is in close contact with the front surface of the housing when the first front door is at the closed position.
